(19) United States
(12) Patent Application Publication
(10) Pub. No.: US 2021/0294263 A1
(43) Pub. Date: Sep. 23, 2021

(54) IMAGE FORMING APPARATUS

(71) Applicant: FUJI XEROX CO., LTD., Tokyo (JP)

(72) Inventors: Toshihiro GODA, Kanagawa (JP); Yukihiro ICHIKI, Kanagawa (JP); Akira SHIMODAIRA, Kanagawa (JP); Keita HASHIMOTO, Kanagawa (JP); Masaki SUTO, Kanagawa (JP)

(73) Assignee: FUJI XEROX CO., LTD., Tokyo (JP)

(21) Appl. No.: 16/940,772

(22) Filed: Jul. 28, 2020

(30) Foreign Application Priority Data
Mar. 19, 2020 (JP) 2020-050140

(51) Int. Cl. G03G 21/20; G03G 15/16; G03G 15/01

(52) U.S. Cl. CPC G03G 21/206; G03G 2215/0119; G03G 15/0194; G03G 15/1615

(57) ABSTRACT

An image forming apparatus includes: a medium transport path; a first image transport path that is disposed so as to oppose the medium transport path and along which an image to be formed on the medium is transported; an image forming part that forms the image and is disposed adjacent to the first image transport path; and a second image transport path that is disposed so as to oppose the medium transport path, that is located at a distance from the image forming part, and along which an image to be formed on the medium is transported, the second image transport path, the first image transport path, and the medium transport path, together surrounding the image forming part.

### CROSS-REFERENCE TO RELATED APPLICATIONS

This application is based on and claims priority under 35 USC 119 from Japanese Patent Application No. 2020-050140 filed Mar. 19, 2020.

### BACKGROUND

### (i) Technical Field

The present disclosure relates to an image forming apparatus.

### (ii) Related Art

An image forming apparatus disclosed in Japanese Unexamined Patent Application Publication No. 2007-304192 includes: a plurality of process cartridges that can be attached to and removed from the body of the apparatus and that are arranged in tandem; a transport belt that is opposed to the process cartridges and that transports a recording medium in the vertical direction; a cover body provided on the body of the apparatus so as to be capable of being opened and closed, the cover body enabling the transport belt to retract and exposing the process cartridges when opened; identifier members provided on the process cartridges and having different shapes or being provided at different positions according to the colors of the process cartridges; identifying members provided on the body of the apparatus to indicate whether the process cartridges are located at proper set positions based on whether or not they interfere with the identifier members; and a transport-belt retracting device that retracts the transport belt toward the cover body when the cover body is closed with any of the process cartridges being located at an improper set position.

### SUMMARY

Aspects of non-limiting embodiments of the present disclosure relate to providing an image forming apparatus in which, compared with an image forming apparatus in which image forming parts are disposed adjacent to multiple image transport paths opposed to a medium transport path, an airflow is more easily formed between the image forming parts and the image transport paths.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a medium transport path; a first image transport path that is disposed so as to oppose the medium transport path and along which an image to be formed on the medium is transported; an image forming part that forms the image and is disposed adjacent to the first image transport path; and a second image transport path that is disposed so as to oppose the medium transport path, that is located at a distance from the image forming part, that is disposed so as to surround the image forming part, together with the first image transport path and the medium transport path, and along which an image to be formed on the medium is transported.

### BRIEF DESCRIPTION OF THE DRAWINGS

Exemplary embodiments of the present disclosure will be described in detail based on the following figures, wherein:

FIG. 1 is a front view showing the internal structure of an image forming apparatus according to a first exemplary embodiment;

FIG. 2 is a sectional view taken along line II-II in FIG. 1;

FIG. 3 is a front view of the image forming apparatus in FIG. 1;

FIG. 4 is a back view of the image forming apparatus in FIG. 1;

FIG. 5 is a side view of the image forming apparatus in FIG. 1, as viewed from arrow V; and

FIG. 6 is a front view showing the internal structure of an image forming apparatus according to a second exemplary embodiment.

### DETAILED DESCRIPTION

### First Exemplary Embodiment

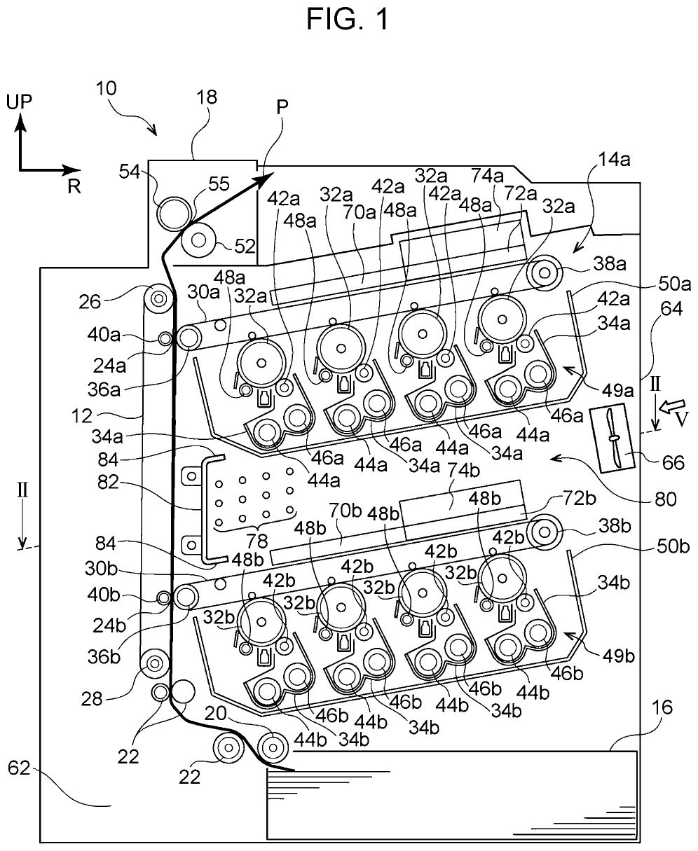

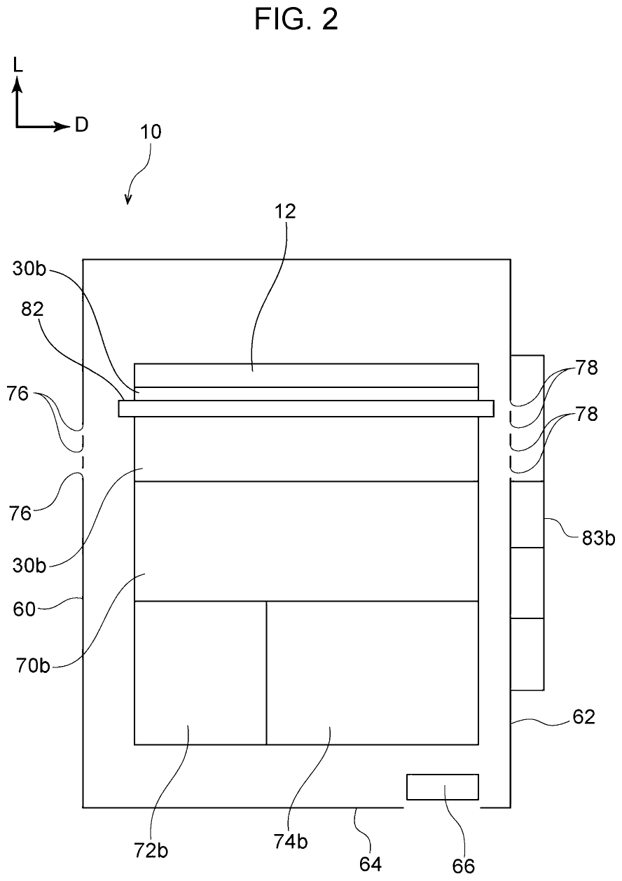

An example of an image forming apparatus according to a first exemplary embodiment of the present disclosure will be described below with reference to FIGS. 1 to 5. In the drawings, arrow UP indicates the upper side in the vertical direction; arrow R indicates the right side in the horizontal direction when facing the apparatus; arrow L indicates the left side in the horizontal direction when facing the apparatus; and arrow D indicates the depth direction in the horizontal direction when facing the apparatus. In the description below, when the top or bottom direction is specified without any presumption, it means the top or bottom direction of the apparatus shown in FIG. 1; when the left or right direction is specified without any presumption, it means the left (L) or right (R) direction of the apparatus shown in FIG. 1 when viewed from the front side; and when the depth (near/far) direction is specified without any presumption, it means the depth direction of the apparatus shown in FIG. 2 when viewed from the front side.

### Overall Structure of Image Forming Apparatus 10

First, the outline of the structure of an image forming apparatus 10 (hereinbelow, simply “apparatus 10”) will be described in sequence along a sheet transport path.

FIG. 1 shows the apparatus 10 in which a near-side cover 60 (see FIG. 2) is removed to show the internal structure. As shown in FIG. 1, the image forming apparatus 10 includes: a transport belt 12, which comes into contact with the back surface of a sheet, serving as an example of a medium on which an image is to be formed, and transports the sheet along a sheet transport path P; an image forming unit 14a and an image forming unit 14b that form images using an electrophotographic system; a sheet tray 16 that stores sheets; and a fixing unit 18 that fixes the images to the sheet. The image forming unit 14a and the image forming unit 14b are provided at a distance from each other.

The sheets stored in the sheet tray 16 are fed to the transport belt 12 by a supply roller 20, serving as an example of a sheet (medium) supply unit. The sheet is transported between the supply roller 20 and the transport belt 12 by transport rollers 22 provided along the transport path P.

Toner images formed by the image forming unit 14a and the image forming unit 14b, opposed to the transport belt 12, are transferred to a sheet supplied to the transport belt 12 at a transfer part 24a and a transfer part 24b. The image forming unit 14a and the transfer part 24a are located on the downstream side, and the image forming unit 14b and the transfer part 24b are located on the upstream side in the sheet transport direction.

The sheet to which the toner images have been transferred is transported from the transport belt 12 to the fixing unit 18, where the toner images are fixed. The sheet is then discharged outside the apparatus 10 or is supplied to the transport belt 12 again through a transport path (not shown).

Next, the outline of the structure of the image forming apparatus 10 will be described in accordance with the positions of the respective components.

As shown in FIG. 1, the sheet tray 16 is provided at the bottom of the image forming apparatus 10. The transport belt 12 extending along the sheet transport path P is provided to the upper left of the sheet tray 16. The transport surface of the transport belt 12 extends in the vertical direction. Multiple transport rollers 22 are provided along the sheet transport path P, between the supply roller 20 and the transport belt 12, at different levels in the vertical direction. With this structure, a sheet supplied from the sheet tray 16 by the supply roller 20 is transported to the left and then upward by the multiple transport rollers 22 and is transported further upward by the transport belt 12.

The image forming unit 14a and the image forming unit 14b are opposed to the transport surface of the transport belt 12. The image forming unit 14a and the image forming unit 14b are disposed on top of each other in the vertical direction with a certain distance therebetween. The image forming unit 14a is disposed above the image forming unit 14b. Hence, the transfer part 24a, which includes the image forming unit 14a and the transport belt 12, is located above the transfer part 24b, which includes the image forming unit 14b and the transport belt 12.

The fixing unit 18 is provided above the transport belt 12. The sheet transported upward by the transport belt 12 is directed sideward by a transport roller (not shown), passes through the fixing unit 18, and is discharged outside the apparatus. Alternatively, the sheet transported upward by the transport belt 12 is transported along a transport path (not shown) and is supplied again to the lower end of the transport surface of the transport belt 12.

Next, the structures of the respective components of the image forming apparatus 10 will be described in detail.

### Transport Belt 12

As shown in FIG. 1, the transport belt 12 is stretched between a roller 26 and a roller 28 that are spaced apart in the vertical direction. The roller 26 on the upper side (i.e., on the downstream side in the sheet transport direction) also serves as a driven part and is rotated by receiving a driving force from a driving source (not shown). The rotation of the roller 26 rotates the transport belt 12. A portion of the transport belt 12 overlapping the sheet transport path P is an example of a “path” along which a medium is transported.

### Image Forming Units 14a and 14b

As shown in FIG. 1, because the image forming unit 14a on the upper side and the image forming unit 14b on the lower side have basically the same structure, the image forming unit 14a will be described in the following explanation. Components related to the image forming unit 14b are denoted by reference numbers with a suffix “b”, and descriptions thereof will be omitted.

The image forming unit 14a includes an intermediate transfer belt 30a (an example of a first image transport path), four image forming parts 49a disposed side-by-side in the circumferential direction of the intermediate transfer belt 30a, and a housing 50a accommodating the image forming parts 49a.

### Intermediate Transfer Belt 30a

As shown in FIG. 1, the intermediate transfer belt 30a is an endless belt stretched between a roller 36a and a roller 38a that are spaced apart in the left-right direction. The roller 36a is located at the left end (i.e., on the downstream side in the toner-image transport direction) of the intermediate transfer belt 30a, and the roller 38a is located at the right end (i.e., on the upstream side in the toner-image transport direction) of the intermediate transfer belt 30a. Thus, the intermediate transfer belt 30a has a horizontally elongated shape.

The roller 38a at the right end is located slightly above the roller 36a at the left end. Hence, the intermediate transfer belt 30a is slightly inclined such that the right end is higher. The roller 36a at the left end has a gear (not shown), which is a driven part receiving a driving force from a driving source. The roller 38a at the right end applies tension to the intermediate transfer belt 30a to maintain the orientation of the intermediate transfer belt 30a.

The roller 36a at the left end is opposed to the transport belt 12. Similarly, a roller 36b supporting an intermediate transfer belt 30b at the left end is also opposed to the transport belt 12. Thus, there is an area surrounded by the transport belt 12, the intermediate transfer belt 30a, and the intermediate transfer belt 30b. The image forming parts 49a are located in this area. Herein, the term “surrounded” means to be surrounded on at least three sides.

### Image Forming Part

The image forming parts 49a each include a photoconductor 32a, a developing device 34a, a developing roller 42a, a stirring roller 44a, a stirring roller 46a, and a charging roller 48a. As described above, the image forming parts 49a are surrounded on at least three sides by the transport belt 12, the intermediate transfer belt 30a, and the intermediate transfer belt 30b. A driving source (not shown) for supplying a driving force is connected to each image forming part 49a.

### Transfer Part 24a

The left end of the intermediate transfer belt 30a is in contact with the transport belt 12. This contact portion serves as the transfer part 24a. A second transfer roller 40a for applying a second transfer bias is disposed so as to oppose the roller 36a with the transport belt 12 therebetween.

### Photoconductor 32a

Four roller-shaped photoconductors 32a are disposed below the intermediate transfer belt 30a so as to be in contact with the intermediate transfer belt 30a. The photoconductors 32a are disposed side-by-side in the left-right direction and are rotated in accordance with the rotation of the intermediate transfer belt 30a. The photoconductors 32a are also disposed in an inclined manner such that the right side is higher, in accordance with the inclination of the intermediate transfer belt 30a.

### Developing Device 34a

Developing devices 34a are disposed below the photoconductors 32a. The developing devices 34a each include a developing roller 42a that develops a toner image on the photoconductor 32a, and two stirring rollers, namely, a stirring roller 44a and a stirring roller 46a, for transporting developer containing toner while stirring.

### Charging Roller 48a

A charging roller 48a for charging the surface of the photoconductor 32a is disposed below the photoconductor 32a, to the left of the developing device 34a. The charging roller 48a to which a voltage is applied is rotated in accordance with the rotation of the photoconductor 32a, while being in contact with the surface of the photoconductor 32a.

### Boards

As shown in FIG. 1, a control board 70a and a control board 72a, serving as an example of a controller for controlling the operation of the image forming unit 14a, and a power supply board 74a, serving as an example of a power supply circuit for supplying voltage to the image forming unit 14a, are disposed above the intermediate transfer belt 30a. The control board 70a is located on the left side of the image forming unit 14a, and the control board 72a and the power supply board 74a are located on the right side of the image forming unit 14a.

The control board 72a is located on the near side, and the power supply board 74a is located on the far side of the apparatus 10.

The control board 70a, the control board 72a, and the power supply board 74a are disposed in an inclined manner along the inclination of the intermediate transfer belt 30a such that the right side is higher.

The power supply board 74a is an example of a low-voltage power supply (LV/LVPS) board.

### Housing 50a

The intermediate transfer belt 30a, the four photoconductors 32a, the four developing devices 34a, the charging rollers 48a, and the driving sources are held together by the housing 50a. The housing 50a, while holding them together, can be attached to and detached from the body of the apparatus 10 to which the transport belt 12 is attached.

The lower side (bottom) of the housing 50a is inclined such that the right side is higher, so as to conform to the positions of the four photoconductors 32a and the four developing devices 34a.

### Driving Source

A driving source (not shown) having a driving gear (not shown) is provided on the near-side surface of the housing 50a. The gear is in mesh with driven parts (driven gears (not shown)) provided on the roller 36a, the photoconductors 32a, the charging roller 48a, the developing roller 42a, the stirring roller 44a, and the stirring roller 46a via multiple intermediate gears (not shown). In this way, the rotary members on the housing 50a can receive rotational driving force from a single driving source. The rotation speeds of the rotary members are adjusted by the peripheral speed ratios of the multiple intermediate gears.

### Fixing Unit 18

As shown in FIG. 1, the fixing unit 18 includes a fixing roller 52, which also serves as a driven part, and a roller-shaped fixing belt 54. More specifically, the driven part includes a gear (not shown) provided integrally and coaxially with the fixing roller 52. The fixing roller 52 is disposed so as to be in contact with the surface of a transported sheet to which toner images are transferred.

The fixing belt 54 is disposed so as to oppose the fixing roller 52 with the sheet transport path P therebetween. The fixing roller 52 and the fixing belt 54 interfere with each other, forming a fixing nip 55. The fixing belt 54 is rotated in a driven manner by the rotation of the fixing roller 52.

In this exemplary embodiment, the rotation speed of the fixing roller 52 in the fixing unit 18 is set to be slightly lower than the sheet transport speed with the transport belt 12. Because of this difference in speed, the sheet transported between the transport belt 12 and the nip 55 becomes slack. Owing to this slack, even when the sheet is simultaneously nipped at the transfer part 24a and the nip 55, the sheet can be transported without being pulled toward the transfer part 24a or the nip 55.

### Structure of Relevant Part

Next, the structure of the relevant part in this exemplary embodiment will be described.

### Ventilation Passage 80

As shown in FIG. 1, in the apparatus 10, an area between the image forming unit 14a and the image forming unit 14b serves as a ventilation passage 80 (an example of an outside-air passage). More specifically, the passage 80 is an area (space) surrounded by: a metal plate 82 covering the left side; the image forming unit 14a covering the upper side; the image forming unit 14b covering the lower side; a cover 64 and a drawing device 66 (described below) covering the right side; a cover 62 covering the far side; and a cover 60 covering the near side. The far side and the near side of the passage 80 may be covered by separately provided walls provided on the inner side of the cover 60 and the cover 62. For example, frames or inner walls formed of metal plates (not shown) may be provided on the inner side of the cover 60 and the cover 62.

More specifically, the upper side of the passage 80 is covered by the bottom surface of the housing 50a of the image forming unit 14a, and the lower side of the passage 80 is covered by the intermediate transfer belt 30b (an example of a second image transport path) of the image forming unit 14b, a control board 70b, a power supply board 72b, and a power supply board 74b.

### Vent Holes 76 and 78

As shown in FIG. 2, the cover 60 on the near side of the passage 80 has multiple vent holes 76, and the cover 62 on the far side has multiple vent holes 78.

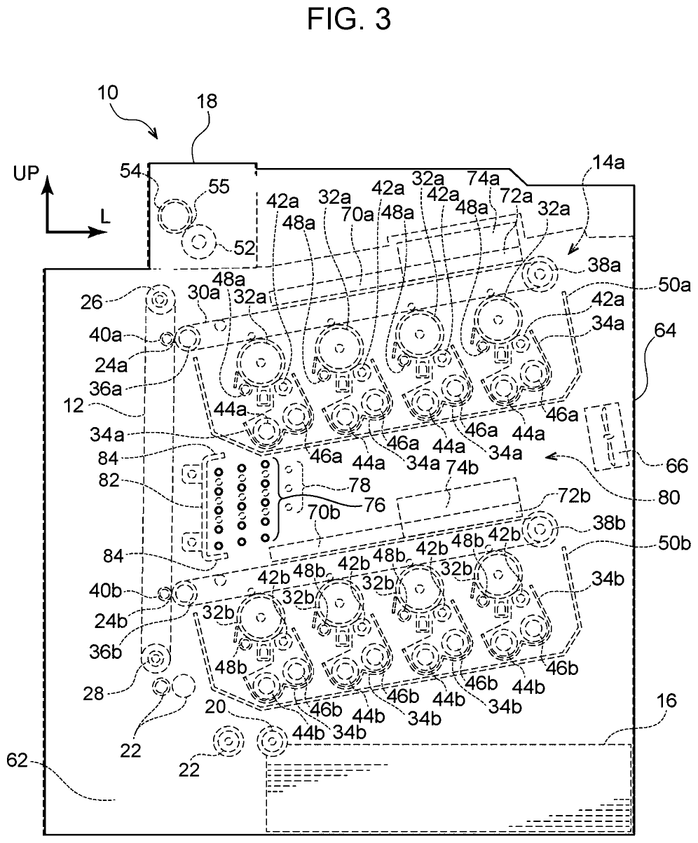

As shown in FIG. 3, the vent holes 76 are provided in the cover 60 constituting the side surface on the near side of the ventilation passage 80.

At least some of the vent holes 76 are located to the left (i.e., closer to the transport belt 12) of the developing device 34a on the extreme left side in the image forming unit 14a on the upper side.

Furthermore, at least some of the vent holes 76 are located to the left of the control board 70b, the power supply board 72b, and the power supply board 74b in the image forming unit 14b on the lower side.

As shown in FIG. 2, the vent holes 78 are provided in the cover 62 constituting the side surface on the far side of the ventilation passage 80.

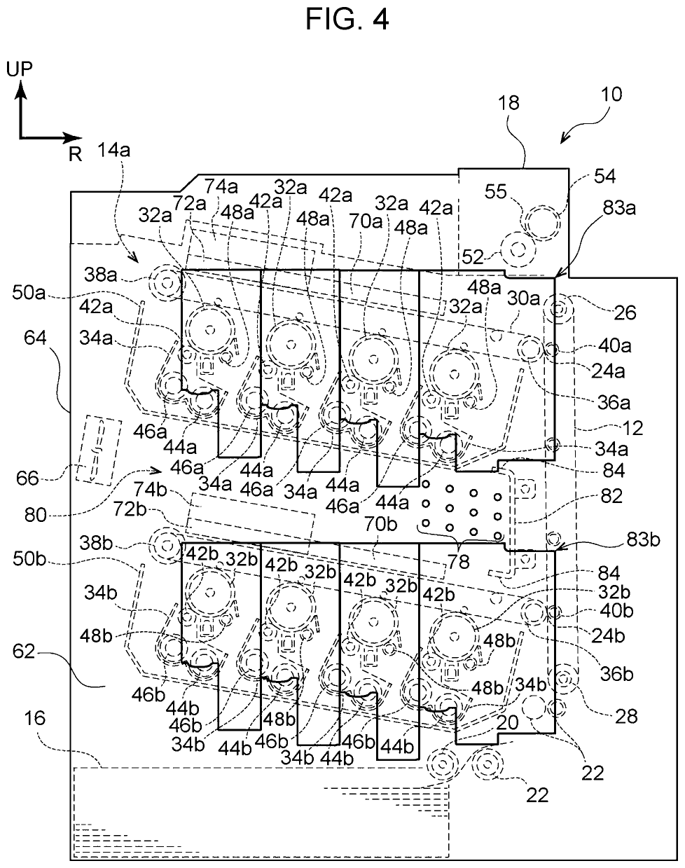

As shown in FIG. 4, upper toner cartridges 83a provided at a position corresponding to the upper image forming unit 14a and lower toner cartridges 83b provided at a position corresponding to the lower image forming unit 14b are provided on the back surface side of the cover 62. Hence, the vent holes 78 in the cover 62 are located at a position between the toner cartridges 83a and the toner cartridges 83b so as to avoid the toner cartridges 83a and 83b.

FIG. 3 shows the positional relationship between the vent holes 76 on the near side and the vent holes 78 on the far side. Whereas the vent holes 76 are distributed in a vertically long area on the near side of the apparatus 10, the vent holes 78 are distributed in a horizontally long area on the far side of the apparatus 10 to avoid the upper and lower toner cartridges 83a and 83b. More vent holes 76 are provided on the left side (i.e., the side closer to the transport belt 12) than the vent holes 78, which are provided so as to avoid the toner cartridges 83a and 83b.

### Drawing Device 66

As shown in FIG. 1, the drawing device 66, which is an example of a generating device that generates an airflow and is an example of a discharging device that discharges air, is provided on the right side of the ventilation passage 80. More specifically, the drawing device 66 is located on the opposite side of the upper intermediate transfer belt 30a and the lower intermediate transfer belt 30b from the transport belt 12 constituting the sheet transport path P.

As shown in FIG. 2, the drawing device 66 is provided on the far side of the apparatus 10.

The drawing device 66 draws the air in the passage 80 from the side near the transport surface of the transport belt 12 (left side) toward the outside of the apparatus 10 (right side), that is, in a direction away from the transport surface, and discharges the air. In this exemplary embodiment, the drawing device 66 is a centrifugal fan.

With this structure, the air in the passage 80 is discharged outside the apparatus 10 by the drawing device 66. As a result, the air outside the apparatus 10 is introduced into the passage 80 through the vent holes 76 and 78.

More specifically, the outside air introduced from the vent holes 76, which are provided on the near left side of the apparatus 10, flows diagonally through the passage 80 and is discharged outside the apparatus 10 by the drawing device 66, which is provided on the far right side of the apparatus 10. The outside air introduced from the vent holes 78, which are provided on the far left side of the apparatus 10, flows from the left to the right on the far side of the passage 80 and is discharged outside the apparatus 10 by the drawing device 66, which is provided on the far right side of the apparatus 10.

### Metal Plate 82

As shown in FIG. 1, the metal plate 82 (an example of a wall), which covers the transport belt 12 as viewed from the transport surface of the transport belt 12, is disposed on the left side of the ventilation passage 80. The metal plate 82 has a flat surface facing the transport surface of the transport belt 12. The metal plate 82 is attached to a frame (not shown) provided in the apparatus 10.

The metal plate 82 is located closer to the transport belt 12 (i.e., the left side) than the vent holes 76 provided in the cover 60 on the near side and the vent holes 78 provided in the cover 62 on the far side of the apparatus 10 are.

The length of the metal plate 82 in the vertical direction is larger than the lengths of the areas in which the vent holes 76 and the vent holes 78 are provided. Hence, the upper end of the metal plate 82 is located above the upper end of the vent hole 76 or the vent hole 78 that is located on the extreme upper side, and the lower end of the metal plate 82 is located below the lower end of the vent hole 76 or the vent hole 78 that is located on the extreme lower side.

The metal plate 82 has bent portions 84 extending in the horizontal direction (left-right direction in the apparatus 10) at the upper and lower ends thereof. The bent portions 84 are formed by bending the upper and lower ends of the metal plate 82.

The bent portions 84 formed at the upper and lower ends of the metal plate 82 extend in a direction away from the transport surface of the transport belt 12. The ends (right ends in FIG. 1) of the bent portions 84 are located to the right of the vent holes 76 or the vent holes 78 that are located on the extreme left side. In other words, the metal plate 82 is formed in a substantially U shape so as to cover the left side, the upper left side, and the lower left side of the areas in the cover 60 on the near side and the cover 62 on the far side in which the vent holes 76 and the vent holes 78 are provided, in a front view of the apparatus 10.

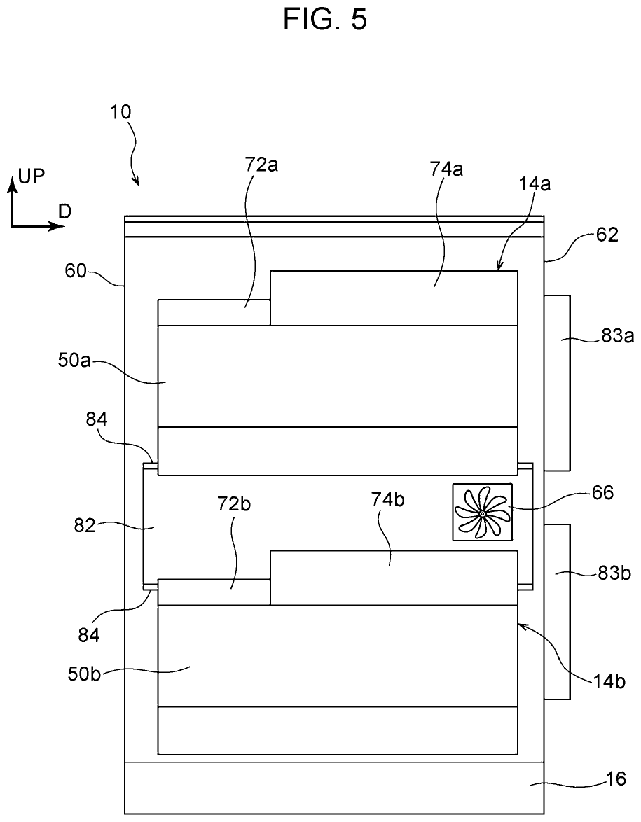

As shown in FIG. 5, when the passage 80 is viewed from direction V in FIG. 1 (i.e., from the right side of the apparatus 10 and a direction parallel to the inclination of the housing 50a and the housing 50b, as viewed from the drawing device 66), the transport belt 12 is behind the metal plate 82 and cannot be viewed.

### Effects

Next, the effects of this exemplary embodiment will be described.

As shown in FIG. 1, in this exemplary embodiment, the ventilation passage 80 is formed between the image forming unit 14a on the upper side and the image forming unit 14b on the lower side. With this structure, it is easy to generate an airflow between the image forming units 14a and 14b, compared with a structure in which the image forming units are close to each other. Hence, air heated by the heat released from the image forming unit 14a or the image forming unit 14b can be easily replaced with fresh air.

The passage 80 is inclined upward in a direction away from the transport belt 12. Hence, the air heated by the heat released from the image forming unit 14a or the image forming unit 14b flows upward along the passage 80. With this structure, the heated air easily flows in the direction away from the transport belt 12, compared with a structure in which the passage 80 is inclined downward in the direction away from the transport belt 12. Hence, in this exemplary embodiment, the air in the passage 80 can be efficiently cooled.

In this exemplary embodiment, the intermediate transfer belt 30a and the intermediate transfer belt 30b are in contact with the transport belt 12 at the transfer parts 24a and 24b. Hence, the left side of the passage 80 is surrounded by these components, and thus, the air in the passage 80 is likely to be trapped in this area. To counter this problem, a structure in which the air in the passage 80 flows toward the right side of the apparatus 10 (i.e., in the direction away from the transport belt 12), as shown in FIG. 1, is desired.

Furthermore, in this exemplary embodiment, the air in the passage 80 is caused to flow (i.e., an airflow is generated) by a generating device (drawing device 66) for generating an airflow. Hence, an airflow is reliably generated in the passage 80, compared with a structure without the drawing device 66.

The drawing device 66 draws (discharges) the air in the passage 80 in the direction away from the transport surface of the transport belt 12. With this structure, even though the left side of the passage 80 is closed by the transport belt 12, an airflow that brings the air in the passage 80 in the direction away from the transport belt 12 is generated, compared with a structure in which the air in the passage 80 is drawn in the depth direction.

Furthermore, the control board 70b is provided above the lower image forming unit 14b with a certain distance from the upper image forming unit 14a. With this structure, an airflow is more efficiently generated around the control board 70b, compared with a structure in which the control board 70b and the upper image forming unit 14a are close to each other. Thus, the air heated by the control board 70b can be efficiently replaced with fresh air.

The power supply board 74b is provided above the lower image forming unit 14b, to the right side of the control board 70b, with a certain distance from the upper image forming unit 14a. With this structure, an airflow is efficiently generated around the power supply board 74b, compared with a structure in which the power supply board 74b and the upper image forming unit 14a are close to each other.

Furthermore, air having a higher temperature can be efficiently replaced with fresh air by the drawing device 66, compared with a structure in which the power supply board 74b, which generates more heat than the control board 70b, is disposed on the left side.

The power supply board 74b is disposed on the far side (i.e., near the drawing device 66) of the apparatus 10. With this structure, air having a higher temperature can be efficiently replaced with fresh air, compared with a structure in which the power supply board 74b is disposed on the near side.

Furthermore, the vent holes 76 and the vent holes 78, through which the outside air passes, are provided to the sides of the sheet transport path P in the passage 80. With this structure, the outside air is efficiently introduced into the passage 80, compared with a structure without the vent holes 76 or the vent holes 78.

Because both the vent holes 76 on the near side of the passage 80 and the vent holes 78 on the far side of the passage 80 are provided, the outside air is efficiently introduced into the passage 80, compared with a structure in which only the vent holes 76 or only the vent holes 78 are provided.

The vent holes 76 on the near side of the passage 80 and the vent holes 78 on the far side of the passage 80 are closer to the transport belt 12 than the extreme-left developing device 34a in the upper image forming unit 14a is. With this structure, an airflow is more efficiently generated around the developing device 34a, compared with a structure in which the vent holes 76 and the vent holes 78 are farther from the transport belt 12 (i.e., to the right side of the developing device 34a) than the developing device 34a is.

The toner cartridges 83a and 83b for supplying toner to the image forming units 14a and 14b are provided on the far-side wall of the apparatus 10. Hence, the cover 62 on the far side of the apparatus 10 has a limited area for the vent holes 78. Thus, the number of the vent holes 78 is smaller than the number of the vent holes 76 on the near side. Accordingly, more outside air is introduced from the vent holes 76 on the near side than the vent holes 78 on the far side.

Because the drawing device 66 is provided on the far side, the outside air (air) introduced from the vent holes 76 on the near side flows diagonally from the near left side toward the far right side in the passage 80. Hence, compared with a case where the drawing device 66 is provided on the near side, more outside air (air) flows through a long path in the passage 80. In other words, the passage 80 is efficiently ventilated.

The metal plate 82 is disposed so as to cover the transport surface of the transport belt 12. With the structure according to this exemplary embodiment, a sheet is transported in the vertical direction on the transport belt 12, along the transport path P. At this time, the sheet sticks to the transport belt 12 by electrostatic force. In this transport state, compared with a structure in which a sheet is transported in the horizontal direction, the sheet is likely to come off the transport path P during transportation.

Furthermore, in this structure, the air in the passage 80 is drawn in the direction away from the transport belt 12 by the drawing device 66. Hence, the sheet is more likely to come off the transport path P due to the airflow during transportation.

To counter this problem, in this structure, the metal plate 82 covers the transport path P. With this structure, compared with a structure in which a wall is provided so as to avoid a medium being transported, influence of airflow on the medium is suppressed.

The metal plate 82 is disposed to the left side of the vent holes 76 and 78. With this structure, the outside air (air) introduced from the vent holes 76 and 78 is more easily guided to the right side, compared with a structure in which the metal plate is disposed to the right side of the vent holes 76 and 78.

The metal plate 82 has the bent portions 84 extending to the right. With this structure, the outside air (air) introduced from the vent holes 76 and 78 is more easily guided to the right side, compared with a structure in which the bent portions 84 extend to the left.

The length of the metal plate 82 in the vertical direction is larger than the distance between the upper end and the lower end of the vent holes 76 and 78. With this structure, the outside air (air) introduced from the vent holes 76 and 78 is more easily guided to the right side, compared with a structure in which the length of the metal plate 82 in the vertical direction is smaller than the distance between the upper end and the lower end of the vent holes 76 and 78.

### Second Exemplary Embodiment

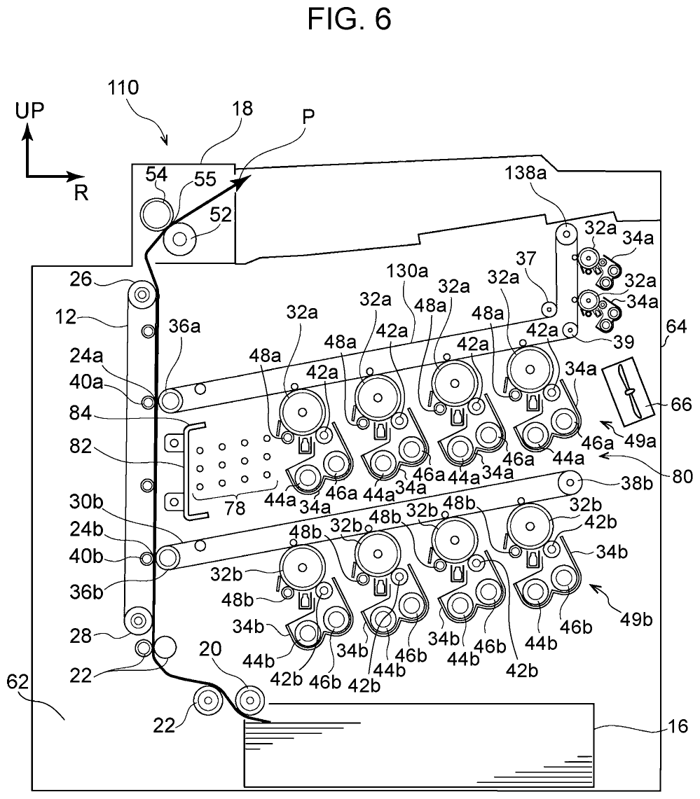

An image forming apparatus 110 according to a second exemplary embodiment of the present disclosure will be described with reference to FIG. 6. Because the image forming apparatus 110 according to this exemplary embodiment is a modification of the image forming apparatus 10 according to the first exemplary embodiment, the components the same as those in the first exemplary embodiment will be denoted by identical or like reference signs, and descriptions thereof will be omitted where appropriate.

As shown in FIG. 6, the right end of an intermediate transfer belt 130a in this exemplary embodiment is bent upward by a support belt 37 and a support belt 39 and is stretched over a roller 138a located above the support belt 37 and the support belt 39. With this structure, the intermediate transfer belt 130a is supported in a substantially L shape with the short line extending upward.

By supporting the intermediate transfer belt 130a in this shape, the intermediate transfer belt 130a having a large perimeter can be disposed in a small area, compared with a structure in which the belt is supported only at the ends thereof. This structure also enables more image forming parts 49a to be disposed adjacent to the intermediate transfer belt 138a.

In this exemplary embodiment, it is assumed that the image forming apparatus 110 discharges heat generated by the image forming parts 49a. Inside the developing devices 34a constituting the image forming parts 49a, developer containing toner and carrier is stirred. As a result, the developing devices 34a are heated by the friction between the toner and the carrier. The developer may also be heated by applying voltage. Due to these factors, the developer reaches a high temperature and is more rapidly deteriorated. Deteriorated developer may cause defective charging or poor image quality.

In the image forming apparatus 110 according to this exemplary embodiment, the image forming parts 49a are disposed adjacent to the intermediate transfer belt 130a and away from the intermediate transfer belt 30b. In other words, the passage 80 (an example of an outside-air passage), through which the outside air passes, is formed between the image forming parts 49a and the intermediate transfer belt 30b.

### Effects

Next, the effects of this exemplary embodiment will be described.

In this exemplary embodiment, the image forming parts 49a are heated by the heat generated by the developing devices 34a. In particular, when there are multiple image forming parts 49a in the apparatus 110, the air near the image forming parts 49a is trapped, and a temperature rise due to the heat generated by the image forming parts 49a becomes more obvious. The air around the image forming parts 49a is drawn by the drawing device 66 and is discharged outside the image forming apparatus 110. Furthermore, the outside air introduced through the vent holes 78 flows into the area surrounded by the transport belt 12, the intermediate transfer belt 130a, and the intermediate transfer belt 30b. As a result, the air around the image forming parts 49a is replaced with fresh air, cooling the image forming parts 49a. The vent holes 78 may be provided so as to overlap any of the image forming parts 49a in front view in FIG. 6. With such a structure, the outside air can be directly guided to the image forming part 49a. Hence, even when there are multiple image forming parts 49a in the apparatus 110, it is possible to cool the image forming part 49a without being influenced by the positions of the other image forming parts 49a.

In the image forming apparatus 110, multiple image forming parts 49a are provided adjacent to the intermediate transfer belt 130a. The vent holes 78 are provided at a position closer to the transport belt 12 than at least the image forming parts 49a provided on the transport belt 12 side with respect to the center, among the multiple image forming parts 49a. With this structure, the outside air introduced from the vent holes 78 flows through a larger number of image forming parts 49a.

More specifically, the vent holes 78 are provided at a position closer to the transport belt 12 than the image forming part 49a provided on the extreme transport belt 12 side, among the multiple image forming parts 49a, is. With this structure, the outside air introduced from the vent holes 78 flows through an even larger number of image forming parts 49a.

In this exemplary embodiment, although there are multiple vent holes 78, at least one of them may be provided at a position overlapping an image forming part 49a in front view in FIG. 6 (i.e., as viewed in a direction intersecting the sheet transport direction in the image forming apparatus 110). In that case, the outside air passing through the vent hole 78 is directly supplied to the image forming part 49a. Hence, compared with a structure in which the outside air passing through the vent hole 78 is supplied to another component, is reflected, and is then supplied to the image forming part 49a, the image forming part 49a is efficiency cooled.

Alternatively, the vent holes 78 may be provided at a position overlapping at least an image forming part 49a that is closer to the transport belt 12 than the other image forming parts 49a, among the multiple image forming parts 49a. With this structure, the outside air introduced from the vent holes 78 is supplied to one image forming part 49a and is then supplied to the other image forming parts 49a. In other words, the outside air passes through a larger number of image forming parts 49a.

More specifically, the vent holes 78 may be provided so as to overlap the image forming part 49a closest to the extreme transport belt 12, among the multiple image forming parts 49a, in front view in FIG. 6 (i.e., as viewed in the direction intersecting the sheet transport direction in the image forming apparatus 110). With this structure, the outside air introduced from the vent holes 78 passes through an even larger number of image forming parts 49a.

### Other Aspects

Although the image forming apparatuses according to the exemplary embodiments of the present disclosure have been described above, various aspects are of course possible without departing from the scope of the present disclosure. For example, it has been described that the image forming units 14a and 14b respectively include four photoconductors 32a and 32b, four developing devices 34a and 34b, and four charging rollers 48a and 48b. However, the number of these components may be larger or smaller than four, as long as it is more than one. Although the transport belt 12 has been described as an example of a medium transport path in the above-described exemplary embodiments, the medium transport path is not limited thereto. For example, in a structure in which continuous paper or label paper is transported along a transport path P supported by rollers on the upstream side and on the downstream side, the transport belt 12 may be omitted. Also when the image forming medium is cut paper, the transport path P may be formed of multiple rollers, and the transport belt 12 may be omitted. In these structures, the area surrounded by the multiple intermediate transfer belts and an image forming medium can be ventilated by using the above-described structures according to the exemplary embodiments.

Although it has been described that the photoconductors 32a and 32b are located below the intermediate transfer belts 30a and 30b in the image forming units 14a and 14b, the positional relationship therebetween may be reversed. Furthermore, although it has been described that the intermediate transfer belts 30a and 30b are stretched over the rollers 36a and 38a and the rollers 36b and 38b disposed at a distance from each other in the left-right direction, the belts may be stretched over more than two rollers. In that case, the intermediate transfer belt stretched over more than two rollers is held in, for example, a substantially triangular or rectangular shape.

In this exemplary embodiment, the upstream side of the sheet transport path P is located on the lower side of the apparatus 10, and the downstream side of the sheet transport path P is located on the upper side of the apparatus 10. With this structure, the sheet is transported from the lower side to the upper side of the apparatus 10. However, the sheet transport path P may be disposed such that, for example, the upstream side and the downstream side thereof are located side-by-side. In that case, for example, the upstream side of the transport path P may be on the left side of the apparatus 10, and the downstream side of the transport path P may be on the right side of the apparatus 10. With this structure, the image forming unit 14a on the upstream side and the image forming unit 14b on the downstream side may be disposed side-by-side along the sheet transport path P.

The upstream side and the downstream side of the sheet transport path P may be reversed in the vertical direction. In that case, the sheet tray 16 is located at the upper end of the apparatus 10, the image forming unit 14b on the upstream side is located above the lower image forming unit 14a, and the fixing unit 18 is located at the lower end of the apparatus 10.

Furthermore, another image forming unit may be disposed between the image forming unit 14a on the downstream side and the image forming unit 14b on the upstream side. At this time, the passage 80, the drawing device 66, the vent holes 76 and 78, and the metal plate 82 may be provided in each space between the image forming units.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a medium transport path;
a first image transport path that is disposed so as to oppose the medium transport path and along which an image to be formed on the medium is transported;
an image forming part that forms the image and is disposed adjacent to the first image transport path; and
a second image transport path that is disposed so as to oppose the medium transport path, that is located at a distance from the image forming part, and along which an image to be formed on the medium is transported, the second image transport path, the first image transport path, and the medium transport path together surrounding the image forming part.

2. An image forming apparatus comprising:
a medium transport path;
a first image transport path that is disposed so as to oppose the medium transport path and along which an image to be formed on the medium is transported;
an image forming part that forms the image and is disposed adjacent to the first image transport path;
a second image transport path that is disposed so as to oppose the medium transport path and along which an image to be formed on the medium is transported, the second image transport path, the first image transport path, and the medium transport path together surrounding the image forming part; and
an outside-air passage provided between the image forming part and the second image transport path and facing the image forming part.

3. The image forming apparatus according to claim 1, further comprising a generating device that generates an airflow between the first image transport path and the second image transport path.

4. The image forming apparatus according to claim 2, further comprising a generating device that generates an airflow between the first image transport path and the second image transport path.

5. The image forming apparatus according to claim 3, wherein the generating device is a discharging device that discharges air between the image forming part and the second image transport path.

6. The image forming apparatus according to claim 4, wherein the generating device is a discharging device that discharges air between the image forming part and the second image transport path.

7. The image forming apparatus according to claim 5, wherein the discharging device discharges the air between the image forming part and the second image transport path from a lower side to a higher side.

8. The image forming apparatus according to claim 6, wherein the discharging device discharges the air between the image forming part and the second image transport path from a lower side to a higher side.

9. The image forming apparatus according to claim 3, wherein the generating device is a drawing device that draws the air between the image forming part and the second image transport path in a direction away from the medium transport path.

10. The image forming apparatus according to claim 5, wherein the generating device is a drawing device that draws the air between the image forming part and the second image transport path in a direction away from the medium transport path.

11. The image forming apparatus according to claim 7, wherein the generating device is a drawing device that draws the air between the image forming part and the second image transport path in a direction away from the medium transport path.

12. The image forming apparatus according to claim 3, wherein the generating device is disposed on the opposite side of the image forming part from the medium transport path.

13. The image forming apparatus according to claim 3, wherein vent holes communicating with an outside of the apparatus are provided on one side of the image forming apparatus in a direction intersecting a medium transport direction and transport directions in the first image transport path and the second image transport path.

14. The image forming apparatus according to claim 13, wherein the vent holes are provided so as to overlap the image forming part, as viewed in a direction intersecting the medium transport direction.

15. The image forming apparatus according to claim 14, wherein
the image forming part is one of a plurality of image forming parts,
the plurality of image forming parts are disposed adjacent to the first image transport path, and
the vent holes are provided so as to overlap the image forming part located closer to the medium transport path, as viewed in the direction intersecting the medium transport direction.

16. The image forming apparatus according to claim 13, wherein the vent holes are provided at a position closer to the medium transport path than the image forming part is.

17. The image forming apparatus according to claim 16, wherein
the image forming part is one of a plurality of image forming parts,
the plurality of image forming parts are disposed adjacent to the first image transport path, and
the vent holes are provided at a position closer to the medium transport path than the image forming part located closer to the medium transport path is, as viewed in the direction intersecting the medium transport direction.

18. The image forming apparatus according to claim 13, wherein the vent holes are provided on both sides of the image forming apparatus in the direction intersecting the medium transport direction and the transport directions in the first image transport path and the second image transport path.

19. The image forming apparatus according to claim 3, further comprising a wall that covers a portion of the medium transport path between the first image transport path and the second image transport path, as viewed from the generating device.

20. The image forming apparatus according to claim 19, wherein the wall has a bent portion extending toward the generating device at an end thereof in the medium transport direction.
